(19) United States
(12) Patent Application Publication
(10) Pub. No.: US 2021/0039402 A1
(43) Pub. Date: Feb. 11, 2021

(54) THERMAL PRINT HEAD ELEMENT, THERMAL PRINT HEAD MODULE AND MANUFACTURING METHOD OF THE THERMAL PRINT HEAD MODULE

(71) Applicant: Chien Hwa Coating Technology , Inc., Hsinchu (TW)

(72) Inventors: Chih-Hui LIU, Hsinchu (TW); Yi-Wei LIN, Hsinchu (TW); Chun-Chen CHEN, Hsinchu (TW)

(21) Appl. No.: 16/920,749

(22) Filed: Jul. 5, 2020

(30) Foreign Application Priority Data
Aug. 5, 2019 (TW) 108127780

(51) Int. Cl. B41J 2/335; B41J 2/36

(52) U.S. Cl. CPC B41J 2/33515; B41J 2/36; B41J 2/3359; B41J 2/3351; B41J 2/3353

(57) ABSTRACT

A thermal print head element includes a substrate, a glaze layer, a heat accumulating layer, a heat generating resistor layer, an electrode layer and an insulating protective layer. The glaze layer is disposed on the substrate to form a ridge portion that linearly extends. The heat accumulating layer covers the ridge portion and the substrate, and is formed with an opening portion that exposes a part of the substrate. The heat generating resistor layer covers the heat accumulating layer. The electrode layer covers the heat generating resistor layer to directly contact with the part of the substrate through the opening portion. The insulating protective layer covers the electrode layer and the heat generating resistor layer, and formed with a through hole so that a soldering region of the electrode layer is exposed outwards from the insulating protective layer through the through hole.

### CROSS-REFERENCE TO RELATED APPLICATION

This application claims priority to Taiwan Application Serial Number 108127780, filed Aug. 5, 2019, which is herein incorporated by reference.

### BACKGROUND

### Field of Disclosure

The present disclosure relates to a thermal print head module and a method for manufacturing the same.

### Description of Related Art

In a manufacturing process of a conventional thermal print head (TPH) element, a step of partially removing a protective layer to expose a soldering region and a step of electrically connecting a driving chip to the soldering region are provided. A common practice in the later step mentioned above is to sequentially solder a metal wire to the soldering region and the driving chip through a wire bonding machine.

However, because the position of the soldering region is much higher than the positional height of the contact of the driving chip, the wire bonding machine is not easy to pull the metal wires (e.g., wire bonding) from the contact of the driving chip to the soldering region, thereby causing the problem of poor success rate of wire bonding.

### SUMMARY

One aspect of the disclosure is to provide a thermal print head element, a thermal print head module and a method for manufacturing the thermal print head module so as to solve the efficiencies mentioned in the prior art, that is, to reduce the positional height of the soldering region by removing a part of the heat accumulating layer between the soldering region and the substrate thereby simplifying the difficulty of the wire bonding machine pulling the metal wires (e.g., wire bonding) from the contact of the driving chip to the soldering region, thereby reducing the defect rate of the thermal print head element.

Another aspect of the disclosure is to provide a thermal print head element, a thermal print head module and a method for manufacturing the thermal print head module for increasing the bonding force of the electrode layer to the substrate so that the substrate can be coupled with the electrode layer tightly, thereby reducing the possibility of the wire bonding machine pulling the metal wires away from the electrode layer when the wire bonding machine is desired to be moved away from the thermal print head element.

In one embodiment of the disclosure, a thermal print head element includes a substrate, a glaze layer, a heat accumulating layer, a heat generating resistor layer, an electrode layer and an insulating protective layer. The glaze layer is disposed on one surface of the substrate, and formed with a ridge portion that linearly extends. The heat accumulating layer covers the ridge portion and the surface of the substrate, and is formed with an opening portion that exposes a part of the surface of the substrate. The heat generating resistor layer covers the heat accumulating layer. The electrode layer covers the heat generating resistor layer, and enters the opening portion to directly contact with the part of the surface of the substrate through the opening portion. The insulating protective layer covers the electrode layer and the heat generating resistor layer, and is formed with a through hole, so that a soldering region of the electrode layer is exposed outwards from the insulating protective layer through the through hole.

According to one or more embodiments of the disclosure, in the thermal print head element, the heat accumulating layer covering the ridge portion forms a convex arc portion in accordance with an overall contour of the ridge portion, and the convex arc portion is covered by the heat generating resistor layer, and is adjacent to the opening portion.

According to one or more embodiments of the disclosure, in the thermal print head element, a minimum straight length of the soldering region of the electrode layer located in the through hole to the surface of the substrate is less that a minimum straight length of the remaining portion of the electrode layer not located in the through hole to the surface of the substrate.

According to one or more embodiments of the disclosure, in the thermal print head element, the heat generating resistor layer is formed with a notch portion overlapping the opening portion and being connected to the opening portion, and the electrode layer directly contacts with the part of the surface of the substrate through the notch portion and the opening portion.

According to one or more embodiments of the disclosure, in the thermal print head element, the heat accumulating layer includes spin-on-glass (SOG) material.

In one embodiment of the disclosure, a thermal print head module includes a thermal print head element mentioned above, a control circuit module and a heat dissipation structure. The control circuit module having a wiring board and a driving chip that is located on the wiring board, electrically connected to the wiring board, and connected to the soldering region of the electrode layer with a metal wire. The heat dissipation structure loads the thermal print head element and the wiring board.

In one embodiment of the disclosure, a method for manufacturing thermal print head module includes steps as follows. A glaze layer is formed on a substrate. A heat accumulating layer is formed on the glaze layer and the substrate in which the heat accumulating layer is formed with an opening portion that exposes a part of the substrate. A heat generating resistor layer is formed on the heat accumulating layer. An electrode layer is formed on the heat generating resistor layer and the opening portion such that a part of the electrode layer is filled within the opening portion to directly contact with the part of the substrate through the opening portion. An insulating protective layer is formed on the electrode layer and the heat generating resistor layer. A part of the insulating protective layer is removed so as to form a through hole, so that a soldering region of the electrode layer is exposed outwards from the insulating protective layer through the through hole. A driving chip is electrically connected to the soldering region of the electrode layer that is located in the through hole with a metal wire.

According to one or more embodiments of the disclosure, in the method for manufacturing thermal print head module, the step of forming the heat accumulating layer on the glaze layer and the substrate further includes that a glass material coated on the glaze layer and the substrate to form a predetermined pattern thereon in which the predetermined pattern includes the opening portion.

According to one or more embodiments of the disclosure, in the method for manufacturing thermal print head module, the step of coating the glass material on the glaze layer and the substrate to form the predetermined pattern thereon further includes that the glass material is coated on the glaze layer and the substrate by a screen printing, coating or printing method.

According to one or more embodiments of the disclosure, in the method for manufacturing thermal print head module, the heat accumulating layer includes spin-on-glass (SOG) material.

The above description is merely used for illustrating the problems to be resolved, the technical methods for resolving the problems and their efficacies, etc. The specific details of the disclosure will be explained in the embodiments below and related drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 is a schematic diagram of a thermal print head module according to one embodiment of the disclosure;

FIG. 2 is a schematic diagram of a thermal print head element according to one embodiment of the disclosure; and

FIG. 3 is a flow chart of a method of manufacturing a thermal print head module according to one embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the disclosure without departing from the scope or spirit of the disclosure.

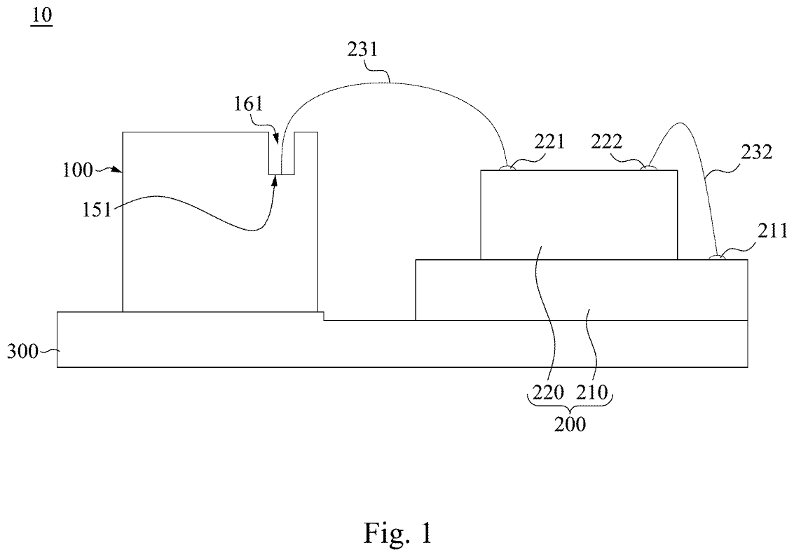

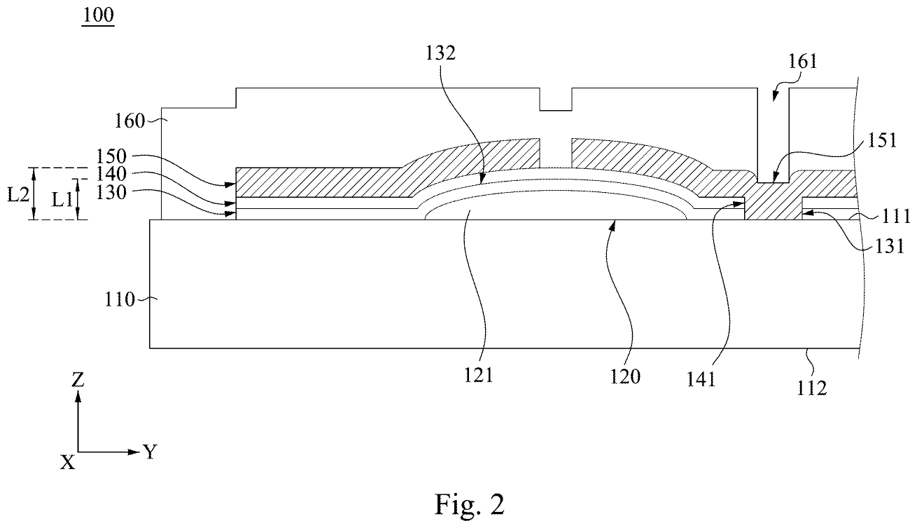

Reference is now made to FIG. 1 and FIG. 2, in which FIG. 1 is a schematic diagram of a thermal print head module 10 according to one embodiment of the disclosure, and FIG. 2 is a schematic diagram of a thermal print head element 100 according to one embodiment of the disclosure. As shown in FIG. 1 and FIG. 2, the thermal print head module 10 includes a thermal print head element 100, a control circuit module 200 and a heat dissipation structure 300. The thermal print head element 100 includes a substrate 110, a glaze layer 120, a heat accumulating layer 130, a heat generating resistor layer 140, an electrode layer 150 and an insulating protective layer 160. The substrate 110 is provided with a first surface 111 and a second surface 112 which are opposite to each other. The glaze layer 120 is disposed on the first surface 111 of the substrate 110, and the glaze layer 120 is provided with a ridge portion 121. The ridge portion 121 extends on the first surface 111 of the substrate 110 along a linear direction (e.g., X axle direction). The heat accumulating layer 130 covers the ridge portion 121 and the first surface 111 of the substrate 110, and the heat accumulating layer 130 is formed with at least one opening portion 131 that penetrates through the heat accumulating layer 130 so as to expose a part of the first surface 111 of the substrate 110. The heat generating resistor layer 140 covers the heat accumulating layer 130. The electrode layer 150 covers the heat generating resistor layer 140. More particularly, a part of the electrode layer 150 enters the opening portion 131 so that the part of the electrode layer 150 directly contacts with the part of the first surface 111 of the substrate 110 through the opening portion 131. The insulating protective layer 160 covers the first surface 111 of the substrate 110, the electrode layer 150 and the heat generating resistor layer 140. The insulating protective layer 160 is formed with a through hole 161. The through hole 161 extends to the electrode layer 150 along a Z axle direction so that a portion of the electrode layer 150 is exposed outwards from the through hole 161, and this portion of the electrode layer 150 is referred as a soldering region 151 hereinafter.

The control circuit module 200 includes a wiring board 210 and a driving chip 220 that is located on the wiring board 210, electrically connected to the wiring board 210, and connected to the soldering region 151 of the electrode layer 150 with a metal wire 231. The heat dissipation structure 300 is connected to the thermal print head element 100 to load the thermal print head element 100 and the wiring board 210.

Therefore, the positional height of the soldering region 151 is reduced by removing a part of the heat accumulating layer 130 between the soldering region 151 and the substrate 110 so as to simplify the difficulty of the wire bonding machine pulling the metal wires 231 (e.g., wire bonding) from the contact of the driving chip 220 to the soldering region 151, thereby reducing the defect rate of the thermal print head element 100.

More particularly, the heat accumulating layer 130 directly covers the first surface 111 of the substrate 110, and directly covers one surface of the ridge portion 121 being opposite to the substrate 110 such that the heat accumulating layer 130 covering the ridge portion 121 forms a convex arc portion 132 in accordance with the overall contour of the ridge portion 121. More specifically, the convex arc portion 132 is adjacent to the opening portion 131. However, in other embodiments, the convex arc portion may be directly connected to the opening portion. The heat generating resistor layer 140 covers the convex arc portion 132 of the heat accumulating layer 130. For example, the heat accumulating layer 130 includes spin-on glass (SOG) material or rotation coating glass.

Furthermore, the positional height of the soldering region 151 of the electrode layer 150 located in the through hole 161 is lower than the positional height of the remaining portion of the electrode layer 150 not located in the through hole 161. In other words, a minimum straight length L1 of the soldering region 151 of the electrode layer 150 located in the through hole 161 to the first surface 111 of the substrate 110 is less that a minimum straight length L2 of the remaining portion of the electrode layer 150 not located in the through hole 161 to the first surface 111 of the substrate 110. The minimum straight length L1 is smaller than the minimum straight length L2.

Thus, since the positional height of the soldering region 151 of the electrode layer 150 is lower than the original positional height of the electrode layer 150, it is helpful to reduce the difficulty of the connection of the metal wire 231 (such as wire bonding) to the soldering region 151.

In addition, when the part of the heat accumulating layer 130 is removed, such that the electrode layer 150 directly contacts with the first surface 111 of the substrate 110, the bonding force of the electrode layer 150 to the substrate 110 can also be improved, so that the electrode layer 150 can be further tightly bonded to the substrate 110 so as to reduce the possibility of the wire bonding machine pulling the metal wires 231 away from the electrode layer 150 when the wire bonding machine is desired to be moved away from the thermal print head element 100.

Furthermore, the heat generating resistor layer 140 is formed with a notch portion 141. The notch portion 141 overlaps the opening portion 131, and the notch portion 141 is connected to the opening portion 131. The part of the electrode layer 150 enters the notch portion 141 and the opening portion 131 to directly contact with the part of the first surface 111 of the substrate 110. Thus, since the part of the heat generating resistor layer 140 corresponding to the opening portion 131 has been removed, the positional height of the soldering region 151 of the electrode layer 150 can also be lowered, thus, it is helpful to reduce the difficulty of the connection of the metal wire 231 (such as wire bonding) to the soldering region 151. However, the disclosure is not limited thereto, and in other embodiments, the position of the heat generating resistor layer 140 corresponding to the opening portion 131 may not be removed.

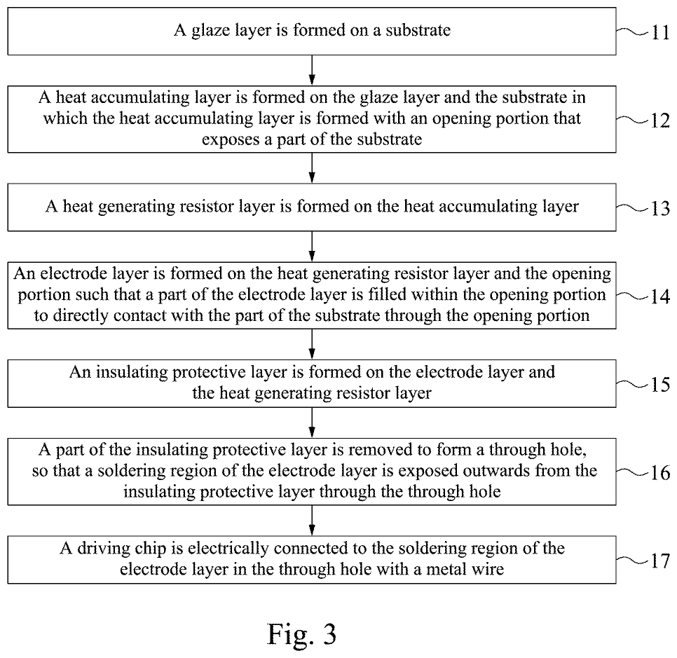

FIG. 3 is a flow chart of a method of manufacturing a thermal print head module 10 according to one embodiment of the disclosure. As shown in FIG. 2 and FIG. 3, the method for manufacturing thermal print head module 10 includes Step11 to Step 17 as follows. In Step 11, a glaze layer 120 is formed on a substrate 110. In Step 12, a heat accumulating layer 130 is formed on the glaze layer 120 and the substrate 110 in which the heat accumulating layer 130 is formed with an opening portion 131 that exposes a part of the substrate 110. In Step 13, a heat generating resistor layer 140 is formed on the heat accumulating layer 130. In Step 14, an electrode layer 150 is formed on the heat generating resistor layer 140 and the opening portion 131 such that a part of the electrode layer 150 is filled within the opening portion 131 to directly contact with the part of the substrate 110 through the opening portion 131. In Step 15, an insulating protective layer 160 is formed on the electrode layer 150 and the heat generating resistor layer 140. In Step 16, a part of the insulating protective layer 160 is removed so as to form a through hole 161, so that a soldering region 151 of the electrode layer 150 is exposed outwards from the insulating protective layer 160 through the through hole 161. In Step 17, a driving chip 220 is electrically connected to the soldering region 151 of the electrode layer 150 that is located in the through hole 161 with a metal wire 231.

In Step 11, more specifically, the glaze layer 120 is formed on the first surface 111 of the substrate 110 by printing a glaze paste by a screen-printing process and sintering the glaze paste at a high temperature. Furthermore, the substrate 110 is, for example, a ceramic or a silicon crystal substrate, but the disclosure is not limited to the material of the substrate 110.

In Step 12, more specifically, a glass material is coated on the glaze layer 120 and the substrate 110 to form a predetermined pattern. The predetermined pattern includes the opening portion 131. For example, the glass material is coated on the glaze layer 120 and the substrate 110 by a screen printing, coating or printing method so that the opening portion 131 exactly exposes the position of the substrate 110 corresponding to the soldering region 151. For example, the glass material is spin-on-glass (SOG) material or rotation coating glass, and the curing temperature thereof is approximately 350° C. to 450° C. It is noted that spin-on-glass (SOG) material is a liquid solvent containing cerium oxide (SiO2), and spin on glass (SOG) and liquid cerium oxide do not contain glaze.

In Step 13, more specifically, a resistance pattern is formed on the heat accumulating layer 130. The resistance pattern is formed with a notch portion 141. The notch portion 141 and the opening portion 131 are overlapped with each other, and are connected to each other. For example, the heat generating resistor layer 140 is formed on the heat accumulating layer 130 by a physical vapor deposition (PVD) method. The material of the heat generating resistor layer 140 is, for example, a TaN group, a TaO group, or the like.

In Step 14, more specifically, a metal film is formed on the heat generating resistor layer 140 and the notch portion 141 by chemical vapor deposition (CVD) or physical vapor deposition (PVD), and then, the metal film is formed to be the electrode layer 150 through a patterning process. Since one part of the electrode layer 150 is filled into the notch portion 141 and the opening portion 131, the part of the electrode layer 150 directly contacts the substrate 110 through the notch portion 141 and the opening portion 131. For example, the material of the metal film is, for example, copper, aluminum or titanium or the like.

In Step 16, more specifically, a portion of the insulating protective layer 160 is partially etched such that a through hole 161 is formed on the insulating protective layer 160 to expose the soldering region 151 beneath the insulating protective layer 160.

In Step 17, more specifically, a metal wire 231 (e.g., wire bonding) is soldered on a first contact 221 of the driving chip 220 and the soldering region 151 in the through hole 161 through a wire bonding machine, and another metal wire 232 (e.g., wire bonding) is soldered on a second contact 222 and a third contact 211 of a circuit board. Thereby, the driving chip 220 is electrically connected to the thermal print head element 100.

It is noted, after the wire bonding machine solders the metal wire 231 (e.g., wire bonding) to the soldering region 151 in the through hole 161, the wire bonding machine tears off the remaining wire as the soldering region 151 leaves. Since the portion of the electrode layer 150 directly adheres to the substrate 110, so that the electrode layer 150 can be coupled to the substrate 110 tightly, thereby reducing the possibility of the wire bonding machine pulling the metal wires away from the electrode layer when the wire bonding machine is desired to be moved away from the thermal print head element.

Although the disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A thermal print head element, comprising:
a substrate;
a glaze layer disposed on one surface of the substrate, and formed with a ridge portion that linearly extends;
a heat accumulating layer covering the ridge portion and the surface of the substrate, and formed with an opening portion that exposes a part of the surface of the substrate;
a heat generating resistor layer covering the heat accumulating layer;
an electrode layer covering the heat generating resistor layer, and entering the opening portion to directly contact with the part of the surface of the substrate through the opening portion; and
an insulating protective layer covering the electrode layer and the heat generating resistor layer, and formed with a through hole, and a soldering region of the electrode layer is exposed outwards from the insulating protective layer through the through hole.

2. The thermal print head element of claim 1, wherein the heat accumulating layer covering the ridge portion forms a convex arc portion in accordance with an overall contour of the ridge portion, and the convex arc portion is covered by the heat generating resistor layer, and is adjacent to the opening portion.

3. The thermal print head element of claim 1, wherein a minimum straight length of the soldering region of the electrode layer located in the through hole to the surface of the substrate is less that a minimum straight length of the remaining portion of the electrode layer not located in the through hole to the surface of the substrate.

4. The thermal print head element of claim 1, wherein the heat generating resistor layer is formed with a notch portion overlapping the opening portion and being connected to the opening portion, and the electrode layer directly contacts with the part of the surface of the substrate through the notch portion and the opening portion.

5. The thermal print head element of claim 1, wherein the heat accumulating layer comprises spin-on-glass (SOG) material.

6. A thermal print head module, comprising:
a thermal print head element of claim 1;
a control circuit module comprising a wiring board and a driving chip that is located on the wiring board, electrically connected to the wiring board, and connected to the soldering region of the electrode layer with a metal wire; and
a heat dissipation structure loading the thermal print head element and the wiring board.

7. A method for manufacturing thermal print head module, comprising:
forming a glaze layer on a substrate;
forming a heat accumulating layer on the glaze layer and the substrate, wherein the heat accumulating layer is formed with an opening portion that exposes a part of the substrate;
forming a heat generating resistor layer on the heat accumulating layer;
forming an electrode layer on the heat generating resistor layer and the opening portion such that a part of the electrode layer is filled within the opening portion to directly contact with the part of the substrate through the opening portion;
forming an insulating protective layer on the electrode layer and the heat generating resistor layer;
removing a part of the insulating protective layer to form a through hole, and a soldering region of the electrode layer is exposed outwards from the insulating protective layer through the through hole; and
electrically connecting a driving chip to the soldering region of the electrode layer located in the through hole with a metal wire.

8. The method for manufacturing thermal print head module of claim 7, wherein the step of forming the heat accumulating layer on the glaze layer and the substrate, further comprises:
coating a glass material on the glaze layer and the substrate to form a predetermined pattern thereon, wherein the predetermined pattern comprises the opening portion.

9. The method for manufacturing thermal print head module of claim 8, wherein the step of coating the glass material on the glaze layer and the substrate to form the predetermined pattern thereon, further comprises:
coating the glass material on the glaze layer and the substrate by a screen printing, coating or printing method.

10. The method for manufacturing thermal print head module of claim 7, wherein the heat accumulating layer comprises spin-on-glass (SOG) material.
